(19) United States
(12) Patent Application Publication
(10) Pub. No.: US 2009/0205044 A1
(43) Pub. Date: Aug. 13, 2009

(54) APPARATUS, SYSTEM, AND METHOD FOR SECURE HARD DRIVE SIGNED AUDIT

(76) Inventors: David Carroll Challener, Raleigh, NC (US); Howard Locker, Cary, NC (US); Philip John Jakes, Durham, NC (US); Randall Scott Springfield, Chapel Hill, NC (US)

Correspondence Address: Kunzler & McKenzie, 8 EAST BROADWAY, SUITE 600, SALT LAKE CITY, UT, 84111, US

(21) Appl. No.: 12/027,761

(22) Filed: Feb. 7, 2008

(51) Int. Cl. G06F 11/00

(52) U.S. Cl. 726/22

(57) ABSTRACT

An apparatus, system, and method are disclosed for secure hard disk signed audit. The apparatus is provided with a plurality of modules configured to functionally execute the necessary steps of monitoring interactions with an audited system, detecting an interrupt event corresponding to an auditable interaction, and logging an audit record for the auditable interaction in response to the interrupt event, wherein the audit record is logged in an access-restricted portion of a portion-securable hard disk. These modules in the described embodiments include a gate module, a detection module, and a logging module.

### BACKGROUND OF THE INVENTION

1. Field of the Invention

This invention relates to operating system audits and more particularly relates to secure hard drive signed audits.

2. Description of the Related Art

A large portion of business transactions also involve computer transactions. A substantial portion of those transactions also involve security sensitive information. Audits are necessary to prevent, or at least track, fraud and deception involving security sensitive information. This is particularly the case where financial transactions are involved. For example, financial institutions, such as security brokerage firms, may want to audit the transactions of their employees for purposes of proving compliance with the Sarbanes-Oxley Act. Military contractors often wish to track employee transactions involving information that is classified secret by the Department of Defense.

With regard to computer transactions, audits are useful for tracking file access, secure key usage, money transfers, emails and other external communications, and the like. Typically, an audited system includes an application or sub-process that is hosted by the operating system. Likewise, the audit records are typically all accessible by the operating system.

Unfortunately, the audit files or applications themselves may be susceptible to tampering. For example, a system intruder may disable auditing functions of the operating system once he has gained access to the system. From that point forward, his transactions with the compromised system are not tracked. Similarly, the intruder may simply delete all audit records to cover his tracks.

### SUMMARY OF THE INVENTION

The present invention has been developed in response to the present state of the art, and in particular, in response to the problems and needs in the art that have not yet been fully solved by currently available system auditing solutions. Accordingly, the present invention has been developed to provide an apparatus, system, and method for secure hard disk signed audit that overcome many or all of the above-discussed shortcomings in the art.

The apparatus is provided with a plurality of modules configured to functionally execute the necessary steps of monitoring interactions with an audited system, detecting an interrupt event corresponding to an auditable interaction, and logging an audit record for the auditable interaction in response to the interrupt event, wherein the audit record is logged in an access-restricted portion of a portion-securable hard disk. These modules in the described embodiments include a gate module, a detection module, and a logging module.

In one embodiment, the apparatus also includes an access module configured to return access between the audited entity and an entity generating the interrupt event. The audited system may include an operating system, and a virtualization module configured to manage the operating system. The logging module may access a first portion of the portion-securable hard disk and the operating system may access a second portion of the portion-securable hard disk. The operating system may be restricted from accessing the first portion of the portion-securable hard disk.

The apparatus may also include a virtualization module configured to support operation of the gate module, the detection module and the logging module independent of an operating system. The virtualization module may also include a validation module configured to give the logging module access to the access-restricted portion of the portion-securable hard disk in response to a determination that the virtualization module is operating in a predetermined operational state and that the virtualization module is authentic.

In a further embodiment, the validation module includes a Trusted Platform Module (TPM) configured to facilitate authentication of the virtualization module in response to a determination that the TPM is operating in a predetermined operational state. In such an embodiment, the validation module may also include a Platform Configuration Register (PCR) configured to hold validation information, and wherein the TPM is further configured to decrypt a password for accessing the access-restricted portion of the portion-securable hard disk in response to a determination that the value of validation information corresponds to an authentic value.

A system of the present invention is also presented. The system may include an portion-securable hard disk configured to restrict access to predetermined portions of the hard disk to certain predetermined entities, an audited operating system in communication with the portion-securable hard disk, and a audit unit in communication with the portion-securable hard disk, and configured to audit interactions of the audited operating system. The audit unit may include a plurality of modules configured to functionally execute the necessary steps of monitoring interactions of the audited operating system, detecting an interrupt event corresponding to an auditable interaction, and logging an audit record for the auditable interaction in response to the interrupt event, wherein the audit record is logged in an access-restricted portion of the portion-securable hard disk. These modules in the described embodiments include a gate module, a detection module, and a logging module.

A method of the present invention is also presented. The method in the disclosed embodiments substantially includes the steps necessary to carry out the functions presented above with respect to the operation of the described apparatus and system. In one embodiment, the method includes monitoring interactions with an audited operating system, detecting an interrupt event corresponding to an auditable interaction, and logging an audit record for the auditable interaction in response to the interrupt event, wherein the audit record is logged in an access-restricted portion of a portion-securable hard disk.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for secure hard disk signed audit;

FIG. 1 is a schematic block diagram illustrating one embodiment of a system for secure hard disk signed audit;

FIG. 2 is a schematic block diagram illustrating one embodiment of a virtualization module;

FIG. 3 is a schematic block diagram illustrating a further embodiment of a system for secure hard disk signed audit;

FIG. 4 is a schematic block diagram illustrating one embodiment of an apparatus for secure hard disk signed audit;

FIG. 5 is a schematic block diagram illustrating a further embodiment of a system for secure hard disk signed audit;

FIG. 6 is a schematic flow chart diagram illustrating one embodiment of a method for secure hard disk signed audit; and

FIG. 7 is a detailed schematic flow chart diagram illustrating a further embodiment of a method for secure hard disk signed audit.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of generating a signal, causing a signal to be generated, or causing execution of a program of machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

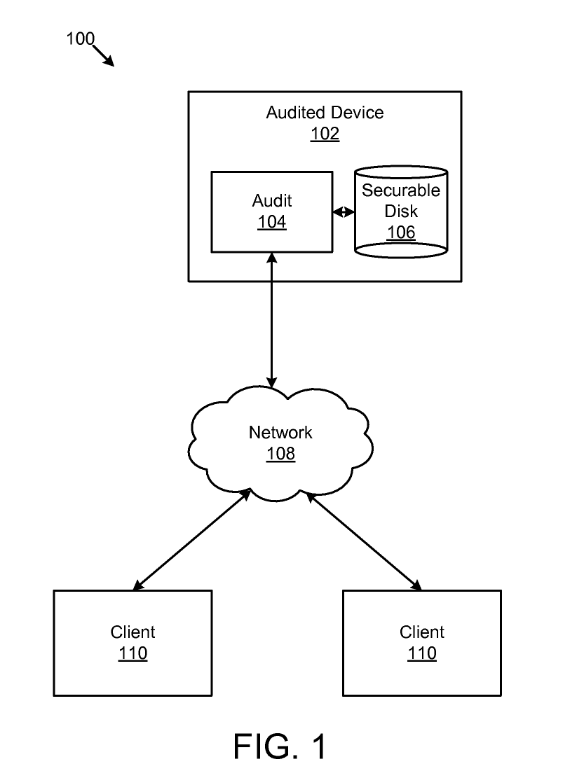

FIG. 1 depicts one embodiment of a system 100 for secure hard disk signed audit. In this embodiment, the system 100 includes an audited device 102 a network 108, and one or more clients 110. The clients 110 may access the audited device 102 through the network 108. Transactions between the audited device 102 and the clients 1 10, or between the audited device 102 and the network 108, may be audited by an audit unit 104. In a further embodiment, transactions between a user and the audited device 102, or between applications operating on the audited device 102 may be audited by the audit unit 104. Records of the audited transactions may be stored on a secure portion of a portion-securable hard disk 106.

In one embodiment, the audited device 102 may include a hardware component such as a server, storage device, or network device. Alternatively, the audited device may be a computer program product, such as an operating system or application. In accordance with the system 100 of FIG. 1, the audited device or user accessible functions of the auditable device 102 may be restricted from accessing certain secure portions of the portion-securable hard disk 106.

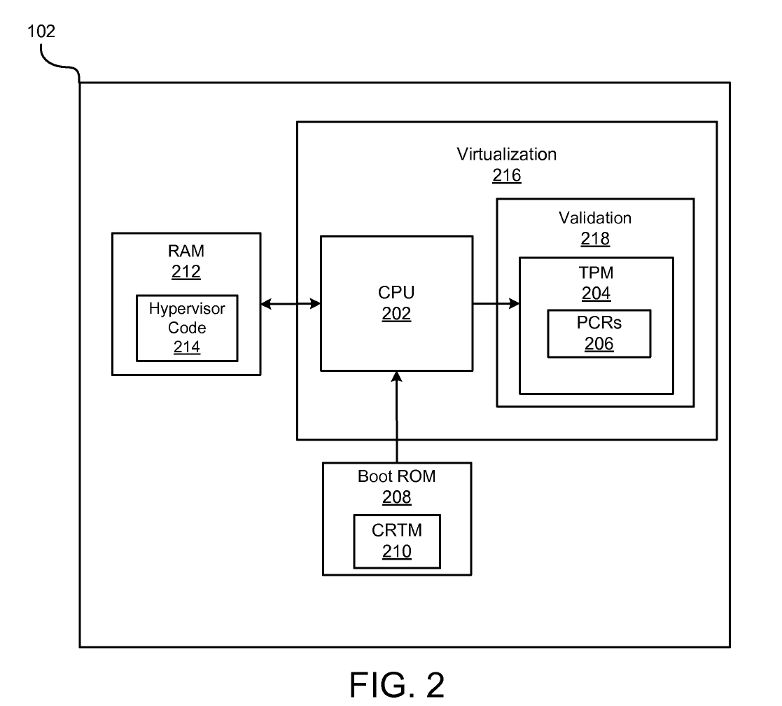

FIG. 2 is a schematic block diagram of one embodiment of an audited system 102. In one embodiment, the device 102 includes a Central Processing Unit (CPU) 202. Additionally, the audited device 102 may include a Trusted Platform Module (TPM) 204. Additionally, the audited device 102 may include boot Read Only Memory (ROM) 208, and Random Access Memory (RAM) 212. In a further embodiment, the audited device 102 may also include a virtualization module 216 and a validation module 218.

In one embodiment, the CPU 202 may access the boot ROM 208 and the RAM 212 to load and execute programs, processes, and applications. Additionally, the CPU 202 may access the TPM 204 to verify the authenticity of code loaded by the CPU 202. In one embodiment, the CPU 202 may include an Intel® brand processor. In an alternative embodiment, the CPU 202 may be an AMD® or other brand of processor. The CPU 202 may be associated with a virtualization module 216. In a specific embodiment, the virtualization module 216 may include an Intel® brand processor configured with Virtualization Technology (VT) and/or LaGrande Technology (LT). In one particular embodiment, the virtualization module 216 may include an executed version of the hypervisor code 214. In a further embodiment, virtualization module 216 may include a verification module 218. The verification 218 module may include the TPM 204 and the PCRs 206.

The TPM 204 may operate in multiple operation states. In one embodiment, these operation states are called localities. Each locality may enable the TPM 204 or the CPU 202 to perform different functions and operations. The TPM 204 may have one or more pins, pads, or other electrical connectors in electronic communication with the CPU 202. The CPU 202 may interact with the TPM 204 by sending signals to the pins, pads, or connectors. For example, in one embodiment, the CPU 202 may trigger the TPM 204 to operate in locality three (3). In another embodiment, the CPU 202 may trigger the TPM 204 to operate in locality two (2) or locality four (4). In various embodiments, the CPU 202 may extend root of trust measurement information to the TPM 204.

A TPM 204 can be used to ensure that only trusted devices and applications have access to access-restricted portions of the portion-securable hard disk 106. Platform boot processes are augmented to allow the TPM 204 to measure each of the components in the system (both hardware and software) and securely store the results of the measurements in Platform Configuration Registers (PCRs) 206 within the TPM 204. These values may be used by the TPM to decrypt passwords for access-restricted portions of the portion-securable hard disk 106, and to digitally sign records stored in those locations.

The TPM 204 may include one or more PCRs 206 for holding measurement information. For example, the CPU 202 may create a hash value corresponding to the hypervisor code using a hash function. The CPU 202 may then communicate the hash value to the TPM 204 for verification and measurement. The TPM 204 may extend the hash value into a predetermined PCR 206 for storage. In one embodiment, extending the hash value to the PCR 206 is referred to as measurement.

In one exemplary embodiment of a boot up operation of the audited device 102, the CPU 202 may access the boot ROM 208 in response to being powered on. In such an example, the CPU 202 may access the boot block or Core Root of Trust Measurement (CRTM) 210 from the boot ROM 208. The boot block 210 may then be verified and measured by the TPM 204, and the measurement value may be stored in the PCR 206. If the boot block is authentic, it may be decrypted and executed by the CPU 202. The boot block process may then access the RAM 212 and repeat the procedure of verification, measurement, decryption, and execution for the subsequent link in the CRTM chain. Each process may select additional processes for verification, measurement, decryption, and execution. For example, a trusted process may access the RAM 212 and retrieve the hypervisor code 214. The hypervisor code 214 may be verified and measured by the TPM 204. The measurement may be stored in the PCR 206, and the CPU 202 may execute the hypervisor, which creates a virtual platform for the audit module 104 and/or an operating system. In a further embodiment, the portion-securable hard disk 106 may be initialized as part of the CRTM chain. In such an embodiment, the portion-securable hard disk 106 would be considered a trusted component of the audited device 102.

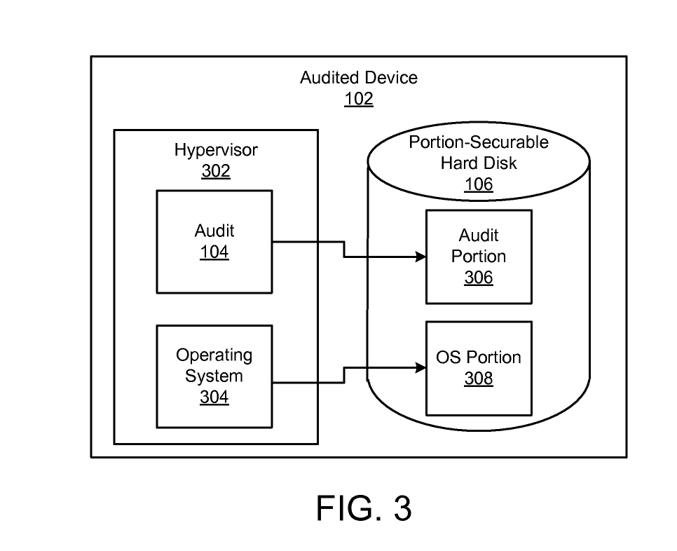

FIG. 3 illustrates a further embodiment of an audited device 102. The depicted embodiment includes the audit unit 104 and the portion-securable hard disk 106 as described in FIG. 1. Additionally, the audited device 102 includes a virtualization module. In the depicted embodiment, the virtualization module is represented by the hypervisor 302.

As described above in FIG. 2, the virtualization module may include the TPM 204 and PCRs 206 configured to facilitate, among other things, booting the hypervisor 302. Once the Hypervisor 302 has booted, the hypervisor 302 may access the RAM 212 and obtain code for executing the audit unit 104. In a further embodiment, the hypervisor 302 may then access ram 212 to access code to boot one or more operating systems 304.

In one embodiment, the audit unit 104 may monitor interactions with the audited operating system 304. The audit module 104 may then detect certain predetermined interactions with the audited operating system 304 and then log audit records regarding those interactions on the audit portion 306 of the portion-securable hard disk 106. The operating system 304 may also be configured to access the portion-securable hard disk 106, however the operating system 304 may only be able to access a designated OS-accessible portion 308 of the portion-securable hard disk 106.

In a certain further embodiment, users of the audited operating system 304 may not be able to perceive that the audit portion 306 of the portion-securable hard disk exists. In an alternative embodiment, the operating system 304 may be unable to access the audit portion 306 of the portion-securable hard disk 106, because the portion may only be accessible through the hypervisor 302.

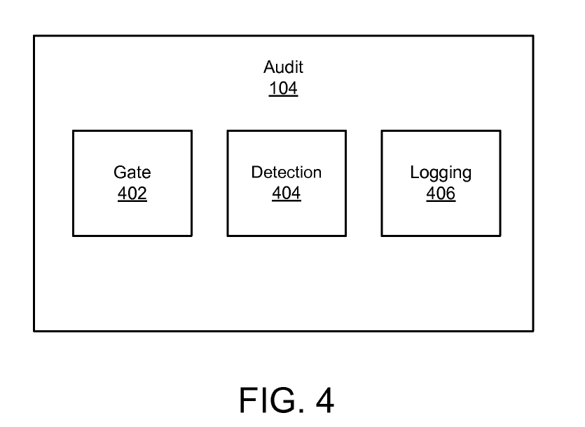

FIG. 4 illustrates one embodiment of an apparatus for secure hard disk signed audit. In the depicted embodiment, the apparatus may include the audit unit 104. In such an embodiment, the audit unit 104 may include a plurality of modules configured to functionally execute the steps of monitoring interactions with an audited system, detecting an interrupt event corresponding to an auditable interaction, and logging an audit record for the auditable interaction in response to the interrupt event, wherein the audit record is logged in an access-restricted portion of a portion-securable hard disk. These modules may include a gate module 402, a detection module 404, and a logging module 406.

The gate module 402 may monitor interactions with an operating system. Alternatively, the gate module 402 may monitor interactions with a storage device, a network routing device, or the like. The gate module 402 may include input/output connections and controls. In a certain embodiment, the gate module 402 may intercept all communications from external entities to the audited device 102. In an alternative embodiment, the gate module 402 may intercept all communications between the operating system 304 and the CPU 202.

The detection module 404 may scan communications intercepted by the gate module 402 to detect an interrupt event corresponding to an auditable interaction. In a further embodiment, the detection module 404 may be configured on detect a certain predetermined set of interrupts corresponding only to auditable interactions. In one exemplary embodiment, the detection module 404 may detect interrupt events such as network packets, a predetermined number or pattern of processor clock ticks, and the like. Alternatively, the detection module 404 may detect access requests for certain files, directories, or applications. In response to detecting a predetermined interrupt event, the detection module 404 may trigger the logging module 406 to record an audit record for the event.

The logging module 406 may log an audit record for the auditable interaction in response to the interrupt event. In a further embodiment, the logging module 406 may record the audit record in an access-restricted portion of the portion-securable hard disk 106. For example, the logging module 406 may record the audit record in the audit portion 306 of the portion-securable hard disk 106. As described in FIG. 2, access to the audit portion 306 may be obtained from the verification module 216.

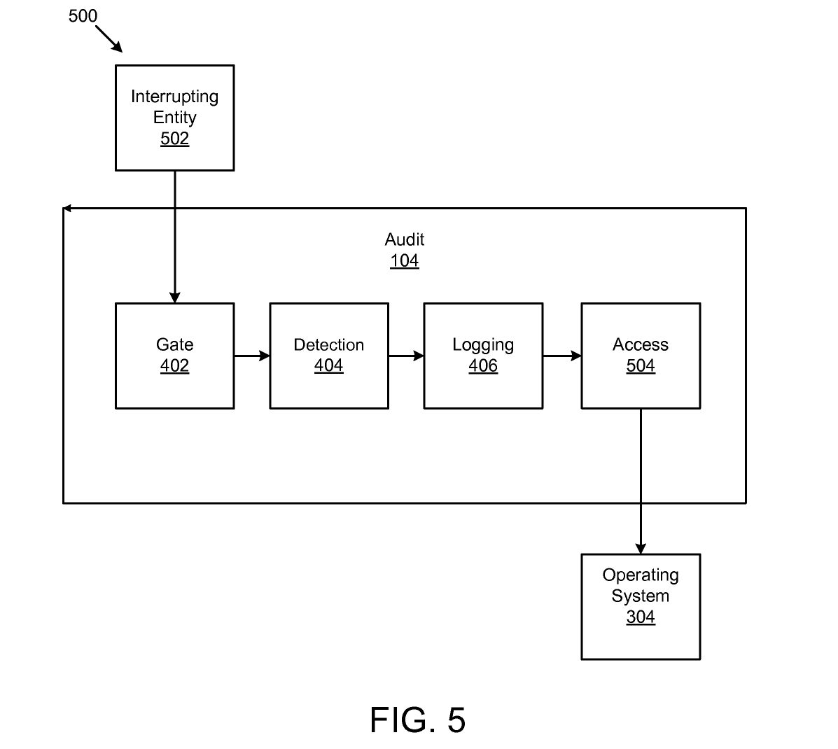

FIG. 5 illustrates a further embodiment of a system 500 for secure hard disk signed audit. The depicted embodiment illustrates a flow of the operations of the various modules of the audit unit 104. The system 500 may include an interrupting entity 502, an audit unit 104, and an audited operating system 304. In one embodiment, the interrupting entity 502 may include a client 110, another operating system 304, or the like. The gate module 402 of the audit unit 104 may intercept an interrupt event generated by the interrupting entity 502.

The detection module 404 may then detect whether the interrupt event corresponds to an auditable interaction between the interrupting entity 502 and the audited operating system 304. If the interrupt event does correspond to an auditable interaction, the logging module 406 may be triggered to record an audit record.

Finally, the access module 504 may return access between the audited operating system 304 and the interrupting entity 502 so that the requested operation may be processed by the audited operating system 304. In one embodiment, the access module 504 may communicate the interrupt to the operating system via the hypervisor 302. Alternatively, the access module 504 may release a hold on communications to the audited operating system 304.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

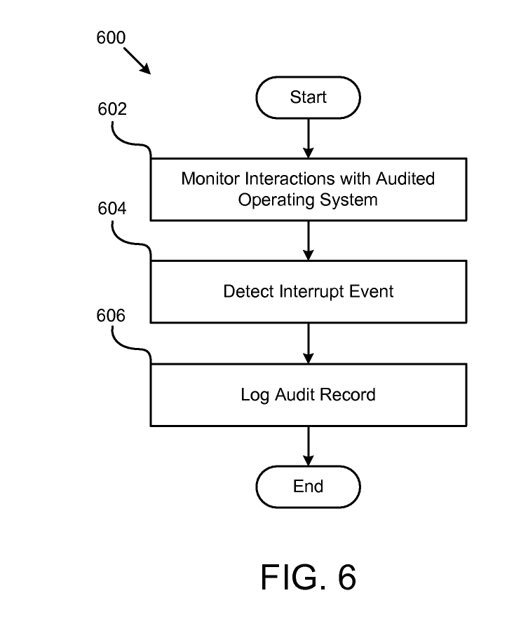

FIG. 6 illustrates one embodiment of a method 600 for secure hard disk signed audit. In the depicted embodiment, the method 600 starts when the gate module 402 monitors 602 interactions with the audited operating system 304. The method 600 continues when the detection module 404 detects 604 an interrupt event communicated to the audited operating system 304 by the interrupting entity 502. The detection module 404 may further detect 604 whether the interrupt event corresponds to an auditable interaction with the audited operating system 304. Finally, the logging module 406 may log 606 an audit record for the auditable interaction. The audit record may be logged 606 on an access-restricted portion of a portion-securable hard disk.

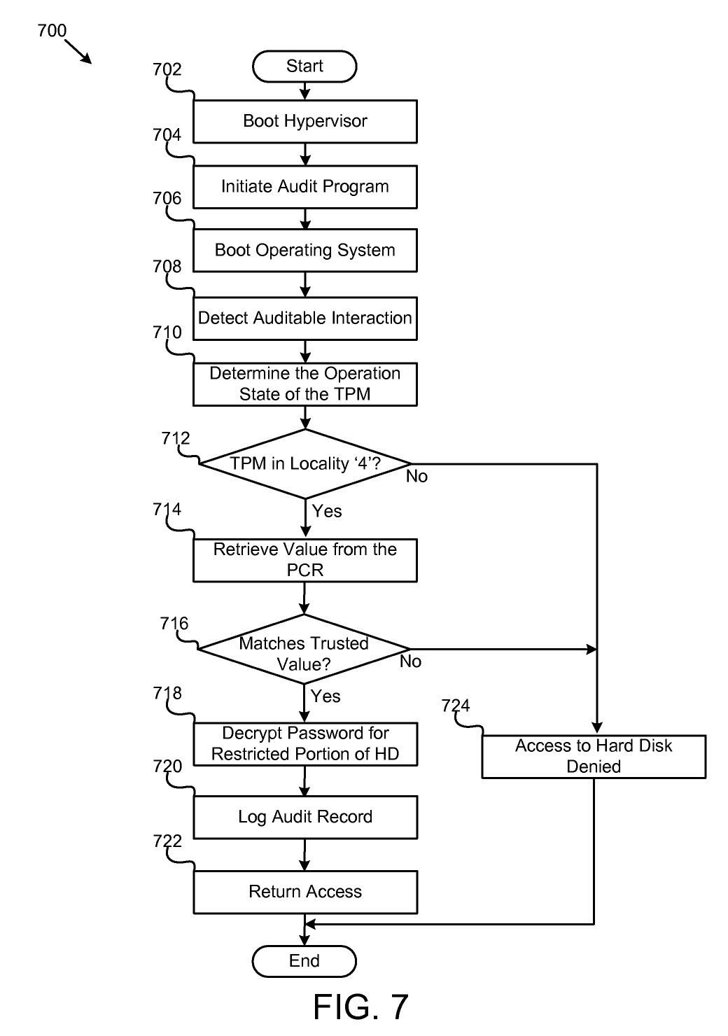

FIG. 7 illustrates a further embodiment of a method 700 of secure hard disk signed audit. In one embodiment, the CPU 202 may first boot 702 a hypervisor 302 as described in FIG. 2. In one embodiment, booting the hypervisor may initialize the virtualization module 216. The virtualization module 216 may then initiate 704 the audit unit 104. Next, the virtualization module 216 may boot 706 the audited operating system 304.

The gate module 402 may continue to monitor interactions with the audited operating system 304 until the detection module 404 detects 708 an auditable interaction. The validation module 718 may then verify that the audit unit 104 attempting to access audit portion 306 of the portion-securable hard disk 106 is authentic by determining 710 the operational state of the TPM. If the validation module 218 determines 712 that the TPM is in locality ‘4,’ then the validation module 218 may retrieve validation information from the PCRs. If the value of the validation information matches 716 to an authentic value, the TPM may decrypt 718 a password for accessing audit portion 306 of the portion-securable hard disk 106.

The logging module 406 may then log 720 an audit record in the audit portion 306 of the portion-securable hard disk 106. When audit unit 104 has gained access to the audit portion of the portion-securable hard disk 106, the access module 504 may return 722 access to the audited operating system 304 to the interrupting entity 502 and the method 700 may end. However, if the validation module 218 determines 712 that the TPM is not operating in the predetermined operational state, or determines 716 that the value stored in the PCR does not match the trusted value, the validation module 218 may not be able to decrypt the password, access to the audit portion 306 of the portion-securable hard disk 106 will be denied 724, and the method 700 will end.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a gate module configured to monitor interactions with an audited system;
a detection module in communication with the gate module, the detection module configured to detect an interrupt event corresponding to an auditable interaction; and
a logging module in communication with the detection module configured to log an audit record for the auditable interaction in response to the interrupt event, wherein the audit record is logged in an access-restricted portion of a portion-securable hard disk.

2. The apparatus of claim 1, further comprising an access module in communication with the logging module, the access module configured to return access between the audited entity and an entity generating the interrupt event.

3. The apparatus of claim 1, further comprising a virtualization module configured to support operation of the gate module, the detection module and the logging module independent of an operating system.

4. The apparatus of claim 3, wherein the virtualization module further comprises a validation module configured to give the logging module access to the access-restricted portion of the portion-securable hard disk in response to a determination that the virtualization module is operating in a predetermined operational state and that the virtualization module is authentic.

5. The apparatus of claim 4, wherein the validation module further comprises a Trusted Platform Module (TPM) configured to facilitate authentication of the virtualization module in response to a determination that the TPM is operating in a predetermined operational state.

6. The apparatus of claim 5, wherein the validation module further comprises a Platform Configuration Register (PCR) configured to hold validation information, and wherein the TPM is further configured to decrypt a password for accessing the access-restricted portion of the portion-securable hard disk in response to a determination that the value of validation information corresponds to an authentic value.

7. The apparatus of claim 3, wherein the audited system further comprises an operating system, and wherein the virtualization module is configured to manage the operating system.

8. The apparatus of claim 7, wherein the logging module is configured to access a first portion of the portion-securable hard disk and the operating system is configured to access a second portion of the portion-securable hard disk, and wherein the operating system is restricted from accessing the first portion of the portion-securable hard disk.

9. A system comprising:
an portion-securable hard disk configured to restrict access to predetermined portions of the hard disk to certain predetermined entities;
an audited operating system in communication with the portion-securable hard disk; and
a audit unit in communication with the portion-securable hard disk, and configured to audit interactions of the audited operating system, the audit unit comprising:
a gate module configured to monitor interactions of the audited operating system;
a detection module in communication with the gate module, the detection module configured to detect an interrupt event corresponding to an auditable interaction; and
a logging module in communication with the detection module configured to log an audit record for the auditable interaction in response to the interrupt event, wherein the audit record is logged in an access-restricted portion of the portion-securable hard disk.

10. The system of claim 9, wherein the audit unit further comprises an access module in communication with the logging module, the access module configured to return access between the audited operating system and an entity generating the interrupt event.

11. The system of claim 9, wherein the system further comprises a virtualization module configured to support operation audit unit independent of the audited operating system.

12. The system of claim 11, wherein the virtualization module further comprises a validation module configured to give the logging module access to the access-restricted portion of the portion-securable hard disk in response to a determination that the virtualization module is operating in a predetermined operational state and that the virtualization module is authentic.

13. The system of claim 12, wherein the validation module further comprises a Trusted Platform Module (TPM) configured to facilitate authentication of the virtualization module in response to a determination that the TPM is operating in a predetermined operational state.

14. The system of claim 13, wherein the validation module further comprises a Platform Configuration Register (PCR) configured to hold validation information, and wherein the TPM is further configured to decrypt a password for accessing the access-restricted portion of the portion-securable hard disk in response to a determination that the value of validation information corresponds to an authentic value.

15. The system of claim 11, wherein the virtualization module is further configured to manage the audited operating system and the audit unit.

16. The system of claim 9, wherein the logging module is configured to access a first portion of the portion-securable hard disk and the audited operating system is configured to access a second portion of the portion-securable hard disk, and wherein the audited operating system is restricted from accessing the first portion of the portion-securable hard disk.

17. A computer program product comprising a computer readable medium having computer usable program code executable to perform operations, the operations of the computer program product comprising:
monitoring interactions with an audited operating system;
detecting an interrupt event corresponding to an auditable interaction; and
logging an audit record for the auditable interaction in response to the interrupt event, wherein the audit record is logged in an access-restricted portion of a portion-securable hard disk.

18. The computer program product of claim 17, wherein the operations further comprise returning access between the audited entity and an entity generating the interrupt event.

19. The computer program product of claim 17, further comprising a virtualization operation configured to manage the operations of the computer program product and the audited operating system, and wherein the virtualization operation manages the computer program product independent of the audited operating system.

20. The computer program product of claim 19, wherein the virtualization operation further comprises a validation operation configured to decrypt a password for accessing the access-restricted portion of the portion-securable hard disk in response to a determination that a value of validation information stored in a Platform Configuration Register (PCR) corresponds to an authentic value.

21. The computer program product of claim 17, wherein the logging operation is configured to access a first portion of the portion-securable hard disk and the audited operating system is configured to access a second portion of the portion-securable hard disk, and wherein the audited operating system is restricted from accessing the first portion of the portion-securable hard disk.

22. A method comprising:
monitoring interactions with an audited operating system;
detecting an interrupt event corresponding to an auditable interaction; and
logging an audit record for the auditable interaction in response to the interrupt event, wherein the audit record is logged in an access-restricted portion of a portion-securable hard disk.
